(19) United States
(12) Patent Application Publication
(10) Pub. No.: US 2014/0156295 A1
(43) Pub. Date: Jun. 5, 2014

(54) SYSTEM FOR DETERMING A SUITABLE CONSUMABLE PRODUCT

(71) Applicant: Trent Cooper, Toowoomba (AU)

(72) Inventor: Trent Cooper, Toowoomba (AU)

(21) Appl. No.: 14/092,623

(22) Filed: Nov. 27, 2013

(30) Foreign Application Priority Data
Nov. 30, 2012 (AU) 2012905212

(51) Int. Cl. G06F 19/00

(52) U.S. Cl. CPC G06F 19/3475
USPC 705/2

(57) ABSTRACT

The present invention is directed to a system for determining a suitable consumable product for a user. The system includes a receiver for receiving product information in relation to a consumable product, and a determiner for determining whether the consumable product is suitable for consumption by the user based on the product information and a user profile of the user. The system is configured to provide a recommendation to the user in response to determining that the consumable product is not suitable.

### TECHNICAL FIELD

The present invention relates to a system for determining a suitable consumable product. The present invention has particular, although not exclusive application to medicaments and health supplements.

### BACKGROUND ART

It can often be difficult to determine whether a consumable product contains substances which may be harmful or cause undesirable effects for a consumer having a particular health condition, taking a particular medication or following a particular dietary plan. For example, it can be difficult for a patient taking a particular medication to determine whether other consumable products may cause adverse effects or reduce the effectiveness of the particular medication. In another example, for a consumer suffering from gluten intolerance, it can be difficult and time consuming to determine whether all of the ingredients on a food packaging are gluten free.

In a supermarket, pharmacy, or any relevant point of purchase including online shopping websites, many types and brands of pharmaceutical products and health supplements are available. Some medicines or health products may contain substances which can reduce the effectiveness of other medicines or health products, or cause harmful effects to a customer taking an incompatible medicine or health product. For a customer having a particular medical condition or taking a particular medication, it can be difficult and time consuming to determine which one of the many consumer medicines or health supplements available from a supermarket or pharmacy would be suitable for consumption by the customer.

Prior art systems such as those described in U.S. Pat No. 7,805,319, U.S. Pat No. 7,999,674 and U.S. Pat No. 6,652,455 are capable of detecting harmful or incompatible substances in food products.

The present invention provides an improved system for determining a suitable consumable product for a user, which may at least partially overcome at least one of the abovementioned disadvantages or provide the consumer with a useful or commercial choice.

It will be clearly understood that, if a prior art publication is referred to herein, this reference does not constitute an admission that the publication forms part of the common general knowledge in the art in Australia or in any other country.

### SUMMARY OF INVENTION

According to one aspect of the invention, there is provided a system for determining a suitable consumable product for a user, the system including
receiving means for receiving product information in relation to a consumable product, and
determining means for determining whether the consumable product is suitable for consumption by the user based on the product information and a user profile of the user,
the system being configured to provide a recommendation to the user in response to determining that the consumable product is not suitable.

Advantageously, the system provides a recommendation which may include an alternative consumable product that is suitable for the user or some useful advice about the options available to the user in the event that a desirable consumable product is not suitable. The system thereby provides the user with a useful solution if the system determines that a consumable product is not suitable.

The consumable product may be any one of the following: a pharmaceutical product, a health supplement, a food product, and a drink product.

The recommendation may include an alternative consumable product which is suitable for consumption by the user. Alternatively, the recommendation may include a suggestion to seek advice from a medical professional.

The receiving means may include a scanner for scanning RFID, bar code or QR code information from the consumer product packaging. The system may be configured to determine product information based on the RFID, bar code or QR code information. The receiving means may be configured to receive scanned information from the user's personal mobile device. The receiving means may be configured to receive user input from a PC or a personal mobile device. The receiving means may be configured to receive the user profile via the scanner.

The system may be configured to obtain the user profile from an online database. The determining means may determine whether the consumable product is suitable for consumption by evaluating whether there is a conflict between the product information and the user profile based on information from a substance information database.

According to another aspect of the invention, there is provided a device for determining a suitable consumable product for a user, the device including
receiving means for receiving product information in relation to a consumable product, and
determining means for determining whether the consumable product is suitable for consumption by the user based on the product information and a user profile of the user,
the device being configured to provide a recommendation to the user in response to determining that the consumable product is not suitable.

According to a further aspect of the invention, there is provided a method for determining a suitable consumable product for a user, the method including the steps of
receiving, via computational means, product information in relation to a consumable product,
determining, via computational means, whether the consumable product is suitable for consumption by the user based on the product information and a user profile of the user, and
providing a recommendation to the user, via computational means, in response to determining that the consumer product is not suitable.

The recommendation may include an alternative consumable product which is suitable for consumption by the user. Alternatively, the recommendation may include a suggestion to seek advice from a medical professional.

The step of receiving may include receiving RFID, bar code or QR code information via a scanner. The method may include determining the product information based on the RFID, bar code or QR code information. The step of receiving may include receiving scanned information from the user's personal mobile device. The step of receiving may include receiving text user input from a PC or personal mobile device.

The step of determining may include obtaining the user profile from user input or from an online database, and determining whether the consumable product is suitable for consumption by evaluating whether there is a conflict between the product information and the user profile based on information from a substance information database.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic diagram of the system for determining a suitable consumable product according to one embodiment of the present invention.

FIG. 2 is a schematic diagram of the user information database and the substance information database of the system of FIG. 1.

FIG. 3 is a flow diagram of the method for determining a suitable consumable product using the system of FIG. 1.

### DESCRIPTION OF EMBODIMENTS

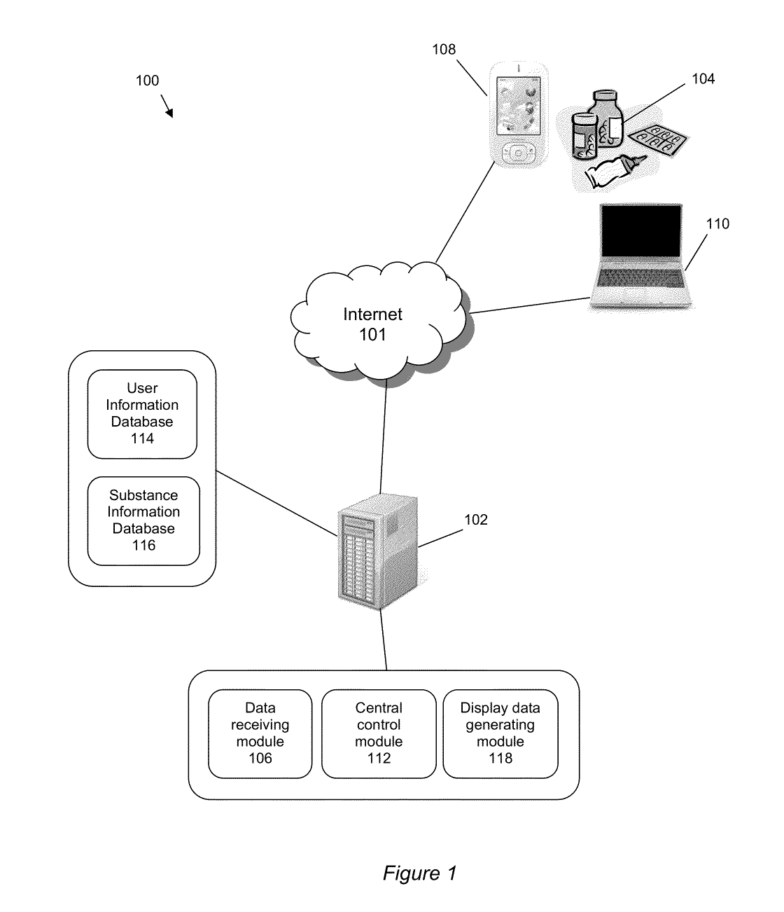

FIG. 1 illustrates a system 100 for selecting a suitable consumable product for a user such as a medicine or a health supplement 104. The system 100 includes a control server 102 that executes a software product (being machine readable instructions) and hosts a product web application on the internet 101. The products web application assists the user in selecting a suitable medicine or health supplement 104.

The control server 102 includes receiving means in the form of a data receiving module 106 for receiving product information in relation to a medicine or health supplement 104 via the user's personal mobile device 108 (e.g. a “smart” phone, PDA, iPAD) or the user's personal computer 110.

In particular, when a user wishes to determine whether a particular medicine or health supplement 104 would be suitable for consumption, the user can use his “smart” phone 108 (e.g. an iPhone) to scan a bar code, QR code or RFID tag on the medicine or health supplement 104. The receiving module 106 is configured to receive the scanned bar code or RFID information.

Alternatively, the user can manually input the bar code, or the brand and name of the medicine or health supplement 104 into the data receiving module 106 via the web application, either through a “smart” phone 108 or a PC 110 (e.g. via text entry and/or drop down menu).

The received bar code, RFID, QR code or product brand/name information is then processed by the central control module 112 to determine the product information as discussed in further detail below.

The control server 102 includes determining means in the form of a central control module 112 for determining whether the medicine or health supplement 104 is suitable for consumption by the user based on information available from a user information database 114 and a substance information database 116. The databases 114, 116 are maintained by the control server 102.

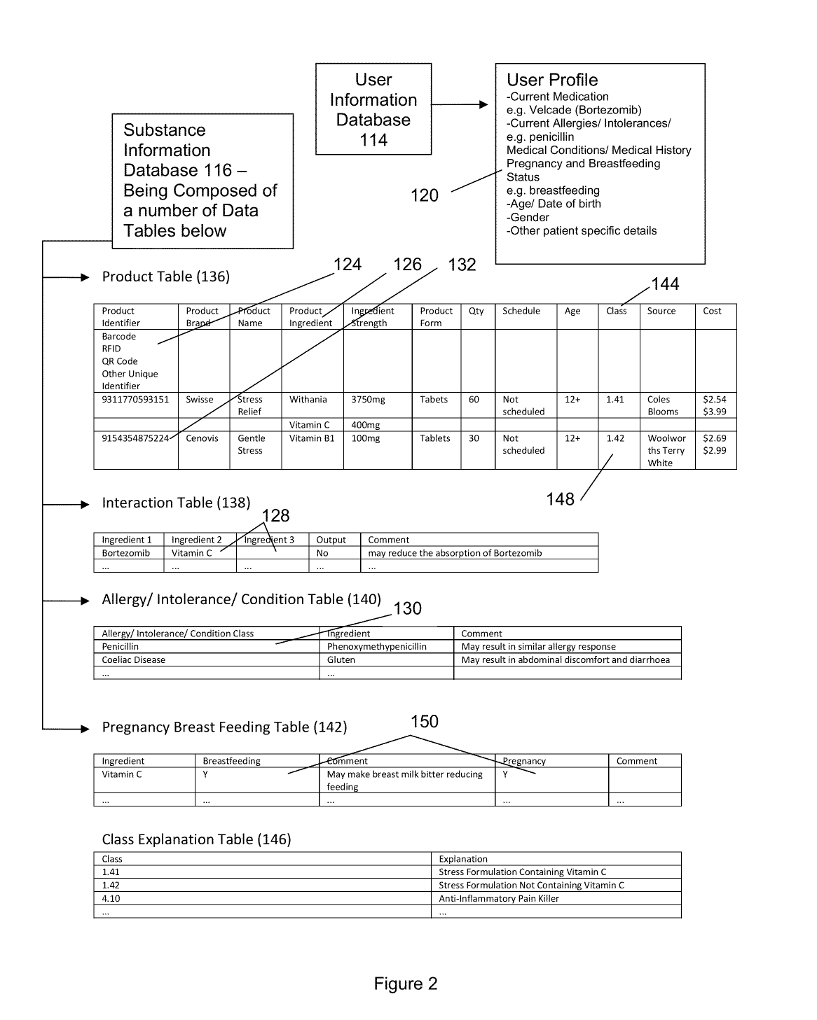

As illustrated in FIG. 2, the user information database 114 contains information entered and updated by the user (e.g. via the products web application). In particular, the user information database contains a profile 120 of the user including information pertaining to any medication the user is currently taking, any medical conditions (e.g. hay fever, pregnancy, gluten intolerance, high cholesterol and/or diabetes) of the user, or any dietary restrictions of the user (e.g. low carb, low fat, vegetarian, breastfeeding, etc).

The substance information database 116 includes a number of data tables including Product table 136, Interaction table 138, Allergy/Intolerance/Condition table 140 and the Pregnancy Breastfeeding table 142 which include an array of product identifiers 124 such as bar codes, RFIDs and QR codes. Each item in the array 124 corresponds to a particular consumable product 104.

Each item in the array 124 and its corresponding bar code(s), RFID(s), QR code(s) is linked with a corresponding list of product information which may include but is not limited to product brand, product name, product ingredient, ingredient strength, product form (e.g. tablet, capsule, powder), product quantity, schedule (e.g. s4 ‘prescription only medicine’, s2 ‘pharmacy only medicine’, ‘not scheduled’ etc), age (any age restrictions on use), class (product classification), source (place of purchase) and the cost (cost to the consumer at the relevant source).

In the product table 136, each item in the array 124 is further linked with the Interaction Table 138 via the ingredient(s) associated with each array. These ingredient(s) are further linked in the Interaction table 138 to a list of incompatible ingredients, which may cause harmful or undesirable effects if consumed together. Interacting ingredients are found in the same row. When the user profile 120 contains a current medication containing an ingredient that is found to interact (i.e. found in the same row) with an ingredient from the selected medicine or health supplement 104 an output is triggered. Two or more ingredients may be involved in an interaction. For the interaction to be valid, all ingredients in the same row must be present for an output to be triggered. In the case of a three ingredient interaction, all three ingredients must be found in the same row before an output is triggered.

Each item in the array 124, via the ingredients associated with each array is also linked with a list of incompatibilities including allergies, intolerances and health conditions via the Allergy/Intolerance/Condition Table 140. The user profile 120 contains a list of user specific incompatibilities including allergies, intolerances and health conditions. If the selected medicine or health supplement 104 contains an ingredient which is present in the same ‘Allergy/Intolerance/Condition Class’ as an ingredient in the user profile 120, an output comment is triggered, whereby the consumption of one or more product substances may cause undesirable effects for a user having one or more of the incompatible conditions.

In addition, each item in the array 124, via the ingredients associated with each array, is also linked with the pregnancy and breastfeeding status in the Pregnancy Breast feeding table 142. The user profile 120 contains the user's pregnancy and breastfeeding status. All ingredients present in the selected medicine or health supplement 104 must be listed in the Pregnancy Breastfeeding table 142 with a ‘Y’ (yes) indicating safe usage under the corresponding Pregnancy or Breastfeeding heading. If any single ingredient present in the selected medicine or health supplement 104 is not present with a ‘Y’ next to it, the product is not safe to use in pregnancy and/or breastfeeding.

Each item in the array 124 has a corresponding class number 144 associated with it. Each class number indicates a particular product class (e.g. pain killer, antihistamine, stress relieving tablet, menopausal treatment etc), as illustrated in the Class Explanation Table 146. Each item in the same class treats a similar condition and has the same or similar functionality to one another. The ingredient composition of the items in the same class can differ. This allows each item in the array 124 to be further linked with a list of consumable products 132 which provide the same or similar function to the consumable product 104. The numerical difference between the classes of two products also signifies the similarity of the products function/intended use. For example two products of class 1.41 and 1.42 (difference of 0.01) would be more similar in product functionality than two products of class 1.41 and 4.10 (difference of 2.69).

Once the bar code, RFID, QR code or product brand and name information is received by the data receiving module 106, the control module 112 uses the Product table 136 in the substance information database 116 to retrieve the corresponding list of product ingredients 126.

The control module 112 uses the Interaction table 138 to determine whether information in the user profile 120 matches any one or more of the incompatible ingredients 128, incompatible allergies, intolerances or health conditions 130 or an incompatible pregnancy or breastfeeding state 150 corresponding to the ingredient 126 linked to the array of the medicine or health supplement 104 selected by the user. In addition, the user selected medicine or health supplement 104 is filtered via a number of other patient specific criteria, saved in the user profile 120. For example, user's age, schedule requirements (prescription only), cost, location (source) and dosage form (e.g. patient can only swallow capsules).

If no match is found, the control module 112 determines that the medicine or health supplement 104 selected by the user is suitable for consumption by the user. If one or more matches are found, the control module 112 determines that the medicine or health supplement 104 selected by the user is not suitable for consumption by the user.

If the control module 112 determines that the medicine or health product 104 selected by the user is not suitable for consumption by the user, the control module 112 identifies the class 144 of the selected medicine or health supplement 104 from the Product Table 136 and filters through the Product Table 136 listings for alternative consumable products 132 with priority given to those products with the same class number followed by products that have a class number that have the lowest numerical difference from the class of the user selected medicine or health supplement 104. The control module 112 searches all related classes until the previous or following subclass has been reached. For example if the class of the user selected product was 1.41, the control module 112 would search all products with classes between 1.400 and 1.499, the extremities of the subclass.

The control module 112 identifies potential alternative products based on identical or closely related class numbers and then filters the results in the same manner as that described above in relation to the selected medicine or health supplement 104. The control module 112 then selects the alternative consumable products that do not contain any unsuitable ingredients for display.

Now referring to FIG. 1, the display data generating module 118 then generates display data for displaying on a display of the user's personal mobile device 108 or PC 110, the list of alternative consumable products 132 which do not contain any unsuitable substances.

If no suitable alternative consumable products are located, the display data generating module 118 may generate a display message including a suggestion to seek advice from a medical professional. The display message may include contact details and the location of a suitable medical practitioner.

Advantageously, the system 100 provides a recommendation which may include an alternative consumable product 104 that is suitable for the user or useful advice about the options available to the user in the event that a selected consumable product 104 is not suitable. The system 100 thereby provides the user with a useful solution if the system determines that a consumable product is not suitable.

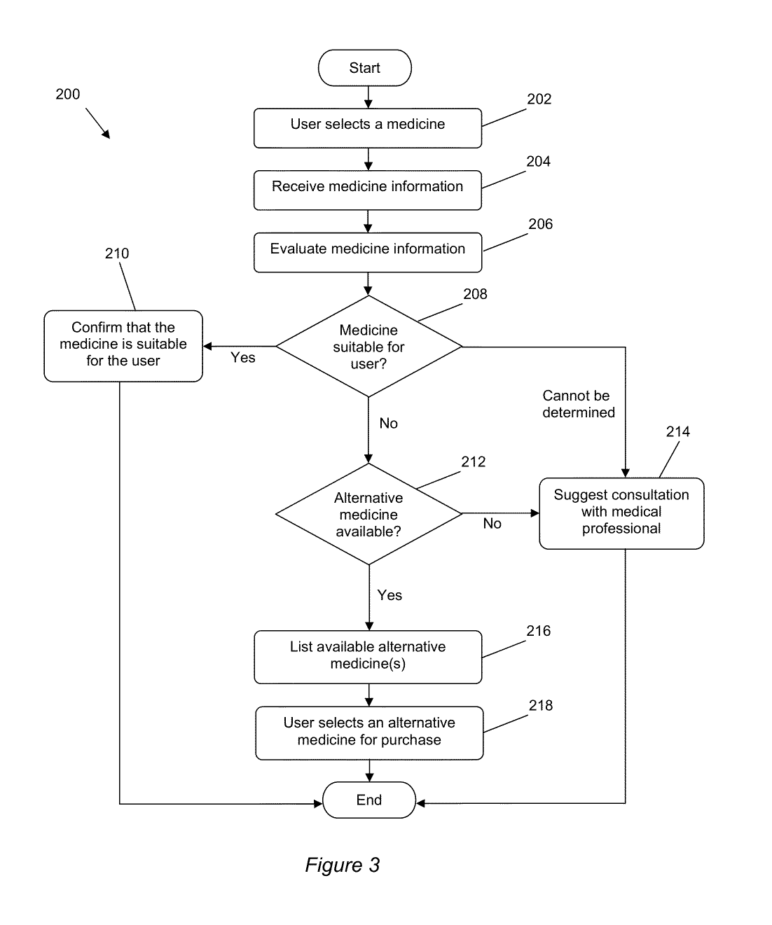

An example method 200 of using the system 100 is described with reference to FIG. 3.

At step 202, the user arrives at a store such as a supermarket, pharmacy or health food store and selects a medicine product 104 from the shelves, such as a multivitamin for the treatment of stress containing two ingredients Withania and Vitamin C (e.g. Swisse Stress Relief).

At step 204, the user launches the products web application on his/her personal mobile device 108, and inputs the medicine information by using the personal mobile device 108 to scan a bar code, QR code or RFID tag of the medicine product 104. The user can also input the medicine information by manually entering the bar code or brand and name of the product 104. The data receiving module 106 receives the medicine information input from the user.

At step 206, the control module 112 uses the Product Table 136 from the substance information database 116 to determine whether the product 104 would be suitable for consumption by the user based on a user profile 120 from the user information database 114. For example, the user profile 120 indicates that the user is currently taking the medicine Velcade, which contains the ingredient Bortezomib to treat cancer. As the look-up Interaction table 138 indicates that ‘Bortezomib’ is an incompatible substance 128 to the user selected product ingredient ‘Vitamin C’ 126, the control module 112 determines that the ‘Swisse Stress Relief’ product 104 is not suitable for consumption by the user.

At query step 208, if the control module 112 determines that the medicine product 104 is suitable for consumption by the user, the method 200 proceeds to step 210. If the control module 112 determines the medicine product 104 is not suitable for consumption by the user, the method 200 proceeds to step 212. In this example the display data module 118 generates the message ‘No you can not use ‘Swisse Stress relief’ with ‘Velcade’, as it contains the ingredient ‘Vitamin C’, ‘which may reduce the absorption of Bortezomib’. The user is then asked if they would like the system to recommend an alternative. If the control module 112 is unable to determine whether the medicine product 104 is suitable for consumption by the user (e.g. due to insufficient information), the method 200 proceeds to 214.

At step 210, the display data module 118 generates a display message confirming that the medicine product 104 is suitable for consumption by the user.

At step 214, the display data module 118 generates a display message suggesting consultation with a medical professional. The message may also include contact information and the location of one or more suitable medical professionals.

At query step 212, the control module 112 identifies the class of the user selected product 104 from the product table 136 from the substance information database 116 to determine whether there are alternative medicines 132 which can be used as a replacement. The control module 112 searches all identical class products first and then filters through products which have a class number that has the lowest numerical difference from the class of the user selected medicine or health supplement 104 until the subclass before and after has been reached. If suitable alternative medicines are available, the method 200 proceeds to step 216. If no suitable alternative medicines are available, the method 200 proceeds to step 214.

At step 216, the control module 112 filters through the list of alternative medicine products 132 from the Product Table 136 with respect to class number. Priority is give to those products with identical class numbers e.g. 1.41 and then to those that have the lowest numerical difference from that of the user selected products class number. For example, Cenovis Gentle Stress containing Vitamin B1 has a class 148 of 1.42, 0.01 difference from the user selected Swisse Stress Relief 1.41 and is present within the accepted subclass limits of 1.400 and 1.499. As illustrated by the Class Explanation Table 146, they are used for similar conditions and Cenovis Gentle Stress would be a suitable alternative. It then selects the alternative medicine products 132 and determines if they are suitable to be used based on the user's profile information 120. For example the control module 112 uses the Interaction Table 138, the Allergy/Intolerance/Condition Table 140 and the Pregnancy/Breastfeeding table 142 (if applicable) to check to see if the patients current medication Bortezomib is compatible with the Cenovis Gentle Stress ingredient Vitamin B1. As Bortezomib is not linked with Vitamin B1 in the Interaction Table 138, the patient has no recorded allergies, intolerances of medical conditions that contraindicate the usage of Vitamin B1 and in this case, the user is not pregnant or breastfeeding, Cenovis Gentle Stress would be a suitable alternative. The data display module 118 then generates display data to display the list of suitable alternative medicine products to the user. The user would receive an output of ‘You can safely use the product ‘Cenovis Gentle Stress’ with your medication profile.

At step 218, the user selects one of the alternative medicine products for purchase. For example, the user decides to buy the ‘Cenovis Gentle Stress’ (Vitamin B1) product instead of the ‘Swisse Stress Relief’.

In one embodiment, the user inputs identification information about his/her current medication into the products web application, for example via a bar code/RFID scanner or QR code on the user's personal mobile device 108, or via manual text/drop down menu entry on the user's personal mobile device 108 or PC 110. The identification information in relation to the user's current medication is saved on the user's profile 120 in the user information database 114. In one embodiment, the identification information is temporarily stored on the user's profile 120. The control module 112 uses the Product table 136 to determine the list of product ingredients 126 contained in the medication on the user's profile 120.

In one embodiment, the server 102 communicates with one or more store inventory databases so that the control module 112 can determine the alternative products which are available for sale at the supermarket/pharmacy/relevant retail outlet in which the user is located or a supermarket/pharmacy/relevant retail outlet nearby.

In another embodiment, the system 100 uses the in-built GPS of a personal mobile device 108 to determine location information of the user to thereby determine the specific store in which the user is located. The control module 112 can use the location information to determine the corresponding inventory database to determine the alternative products that are also available for purchase from the same store. The control module 112 also uses the location information to provide information of suitable medical practitioners located nearby.

In a further embodiment, the control server 102 maintains a number of different databases having various look-up tables. For example, one look-up table contains information about the substances contained in consumable products, and a different look-up table contains a list of substances commonly found in medicines or health supplements linked with substances and medical conditions which are incompatible therewith.

In another embodiment, the control server 102 communicates via the internet 101 with one or more product cost databases (not shown) so as to allow the control module 112 to determine and recommend alternative store locations and product selections based on cost queries.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A system for determining a suitable consumable product for a user, the system including:
a receiver for receiving product information in relation to a consumable product, and
a determiner for determining whether the consumable product is suitable for consumption by the user based on the product information and a user profile of the user,
wherein the system is configured to provide a recommendation to the user in response to determining that the consumable product is not suitable.

2. A system as claimed in claim 1, wherein the recommendation includes one or more alternative consumable products that are suitable for the user.

3. A system as claimed in claim 2, wherein the alternative consumable products are determined based upon consumable product class number/product similarity.

4. A system as claimed in claim 3, wherein priority is given to alternative consumable products with the lowest class differential i.e. products that are most similar to the selected consumable product.

5. A system as claimed in claim 1, wherein the recommendation includes some useful advice about the options available to the user in the event that a desirable consumable product is not suitable.

6. A system as claimed in claim 1, wherein the determiner determines the consumable product is not suitable for consumption by evaluating that there is conflict between an ingredient of the product and any one or more of a current medication or health supplement, allergy, intolerance, health condition, pregnancy, breastfeeding status, age, gender or other characteristic of the user as indicated in the user profile.

7. A system as claimed in claim 1, wherein the receiver includes a scanner for scanning RFID, bar code, QR code information or other indicator from the consumer product packaging, and the system is configured to determine product information based on the RFID, bar code, QR code information or other indicator.

8. A system as claimed in claim 1, wherein the receiver is configured to receive scanned information from the user's personal mobile device.

9. Advice for determining a suitable consumable product for a user, the device including
a receiver for receiving product information in relation to a consumable product, and
a determiner for determining whether the consumable product is suitable for consumption by the user based on the product information and a user profile of the user,
wherein the device is configured to provide a recommendation to the user in response to determining that the consumable product is not suitable.

10. A method for determining a suitable consumable product for a user, the method including the steps of
receiving, via a computational device, product information in relation to a consumable product,
determining, via the computational device, whether the consumable product is suitable for consumption by the user based on the product information and a user profile of the user, and
providing a recommendation to the user, via the computational device, in response to determining that the consumer product is not suitable.

11. A method as claimed in claim 10, wherein the recommendation includes one or more alternative consumable products that are suitable for the user.

12. A method as claimed in claim 11, wherein the alternative consumable products are determined based upon consumable product class number/product similarity.

13. A method as claimed in claim 12, wherein priority is given to alternative consumable products with the lowest class differential i.e. products that are most similar to the selected consumable product.

14. A method as claimed in claim 10, wherein the recommendation includes some useful advice about the options available to the user in the event that a desirable consumable product is not suitable.

15. A method as claimed in claim 10, wherein the step of determining involves determining the consumable product is not suitable for consumption by evaluating that there is conflict between an ingredient of the product and any one or more of a current medication or health supplement, allergy, intolerance, health condition, pregnancy, breastfeeding status, age, gender or other characteristic of the user indicated in the user profile.

16. A method as claimed in claim 10, wherein the step of receiving includes scanning RFID, bar code, QR code or other indicator allowing product identification.

17. A method as claimed in claim 16, further including determining the product information based on the RFID, bar code, QR code or other indicator from the product packaging.

18. A method as claimed in claim 16, wherein the step of receiving includes receiving scanned information from the user's personal mobile device.

19. A method as claimed in claim 10, wherein the step of determining includes obtaining the user profile from user input or from an online database, and determining whether the consumable product is suitable for consumption by evaluating whether there is a conflict between the product information and the user profile based on information from a substance information database.

20. A method as claimed in claim 10, further including the step of selecting a recommended alternative product for purchase.
